(19) United States
(12) Patent Application Publication
(10) Pub. No.: US 2010/0171859 A1
(43) Pub. Date: Jul. 8, 2010

(54) Projection and Registration Device

(75) Inventor: Jouke Caspar Verlinden, Almere (NL)

Correspondence Address: PEACOCK MYERS, P.C., 201 THIRD STREET, N.W., SUITE 1340, ALBUQUERQUE, NM, 87102, US

(73) Assignee: Technische Universiteit Delft, Delft (NL)

(21) Appl. No.: 12/691,939

(22) Filed: Jan. 22, 2010

Related U.S. Application Data
(63) Continuation-in-part of application No. PCT/NL2008/050516, filed on Jul. 25, 2008.

(30) Foreign Application Priority Data
Jul. 25, 2007 (NL) 2000778

(51) Int. Cl. H04N 5/222; G06F 3/041

(52) U.S. Cl. 348/333.01; 345/173; 348/E05.022

(57) ABSTRACT

A projection and recording device, provided with a processing and control unit, a memory for recording images and other data, an input/output interface, a controllable camera, a touch screen for the input and display of data and images, a position determining system for determining the position of at least one object in relation to the projection and recording device, with images recorded by the camera being storable in the memory and displayable on the touch screen, and a projector for projecting an image stored in the memory onto the at least one object, whereby the cooperation between the position determining system and the projector enables the projector to project images onto the object.

### CROSS-REFERENCE TO RELATED APPLICATIONS

This application is a continuation application of International Patent Cooperation Treaty (PCT) Application Serial No. PCT/NL2008/050516, entitled “Projection and Registration Device”, to Technische Universiteit Delft, filed on Jul. 25, 2008, which is a continuation application of Netherlands Patent Application Serial No. NL 2000778, to Technische Universiteit Delft, filed on Jul. 25, 2007, and the specifications and claims thereof are incorporated herein by reference.

### STATEMENT REGARDING FEDERALLY SPONSORED RESEARCH OR DEVELOPMENT

Not Applicable.

### INCORPORATION BY REFERENCE OF MATERIAL SUBMITTED ON A COMPACT DISC

Not Applicable.

### COPYRIGHTED MATERIAL

Not Applicable.

### BACKGROUND OF THE INVENTION

1. Field of the Invention

The invention relates to a projection and recording device, provided with a processing unit, a memory, an input/output interface, a controllable camera, a position determining system for determining the position of at least one object in relation to the projection and recording device, and a projector for projecting an image stored in the memory onto the at least one object.

2. Description of Related Art

Such a device is known, for example, from the U.S. Pat. No. 6,764,185. This device comprises an interactive display system, with a sensor for detecting a relationship between a mobile coordinate frame and a stable coordinate frame, and means for partitioning an image to be reproduced into a black image portion having a fixed relationship to the mobile coordinate frame, a stable image portion within the black image portion having a fixed relationship to the stable coordinate frame, and a mobile image portion within the stable image portion having a fixed relationship to the mobile coordinate frame. The system comprises a memory, a processing unit and an input/output interface.

The system known from the U.S. Pat. No. 6,764,185 can be used to project an image onto a display surface such as a projection screen, with the projector being movable and a portion of the image displayed on the projection screen remaining constant, while another portion of the projected image moves with the projector, so that this can be used as, for example, a pointer in a manner as comparable to a mouse and a cursor. Operation by a user takes place via a few push buttons. However, the drawback of this system is that the user can only influence the projected image to a limited degree and with little flexibility. Moreover, the U.S. Pat. No. 6,764,185 is based on projecting onto a screen in a predetermined starting position in relation to the projector.

### BRIEF SUMMARY OF THE INVENTION

An object of the present invention is to provide a projection and recording device with which the user is enabled to projecting the images in a very flexible manner allowing him to influence and record the projected images in association with the images of the surroundings.

This objective is achieved by a projection and recording device according to claim 1. Such a device allows images to be projected onto any object of any shape. In this way it is possible, for example, to visualize alterations made to a prototype or a scale model, without having to effectuate these alterations in reality. The alterations may relate to shape, color and other visual features of the object. Non-visual aspects can also be visualized. It is, for example, possible to show results of calculations, simulations and measuring results such as, for example, showing flows and temperature changes during injection molding, or strength and tension behavior of products, pedestrian flows in scale models, etc. Due to the positioning device, the position of the object upon which the image is projected is known, thus the projector is controllable so that the image to be projected is projected upon the correct object. The use of a touch screen as input and display unit not only allows making alterations via a menu to that which is projected and recorded, but it also facilitates in a simple manner, for example by touching portions of displayed images, to identify these for further processing with the aid of, for example, a menu structure, which is also displayed and operable via the touch screen.

### DESCRIPTION OF THE INVENTION

In a preferred embodiment, the object is identifiable with the aid of the touch screen. This makes it possible, for example, to alternately view several versions of the object such as, for example, prototype or scale model, with the alterations or modifications projected thereon.

The versatility of the device is further increased if the device is designed to display images that are stored in the memory on the touch screen. This allows, for example, images that have previously been stored in the memory to be combined with each other and with images that are projected and recorded by the camera, and allows these combined images to be manipulated.

If the device can be coupled with a user system, it becomes possible to also draw on the images generated or processed by that user system. Examples of user systems that can be conveniently combined with a device according to the invention include a 2-Dimensional drawing system, a 3-Dimensional drawing system, a simulation system, an image processing system, or a combination of these. It is further advantageous for both the device and the user system, if this is coupled to the device according to the invention, to be controllable by means of input data entered via the touch screen.

The flexibility and functionality are augmented especially if images can be stored in the memory via the touch screen. For example, images displayed on the touch screen and which may be combinations of images obtained from various sources can then be edited by touch, for example, with the aid of functionality in the user system, and an image thus edited can be stored and/or projected.

If the device is equipped to provide images stored in the memory with attributes relating to position and orientation, then it is also possible to combine images in the proper positional relationship afterwards, that is to say after they have been saved. It is, of course, an advantage if the projector is designed to project an image, taking into account the respective position and orientation attributes. The image is then always projected to the correct position and in the correct orientation.

To provide the device according to the invention with a special application possibility, the same is equipped with a microphone and the sound recorded by the microphone can be stored in the memory. This makes it possible, for example, to add commentary. In order to couple the recorded sound to one or several images, it is auspicious to provide image and sound stored in the memory with a synchronization attribute. Providing the device according to the invention with, or coupling it to, a sound reproduction device such as a loudspeaker will allow images accompanied by relevant sound to be combined and reproduced at another moment in time and possibly also in another location.

In certain cases it is advantageous for the device to be provided with several projection systems. This makes it possible, for example, to project images viewed from different perspectives or viewing angles. Moreover, different users are simultaneously able to conduct the projection, with each touch screen being usable by the user for his own purpose and/or for sharing observations/model modifications with others.

### BRIEF DESCRIPTION OF THE SEVERAL VIEWS OF THE DRAWINGS

The invention will now be further elucidated by way of a description of an exemplary embodiment of the invention and with reference to the appended drawing, in which:

FIG. 1 shows a schematic view of an exemplary embodiment of a device according to the invention, and

FIG. 2 shows a block diagram of components of the device according to FIG. 1.

### DETAILED DESCRIPTION OF THE INVENTION

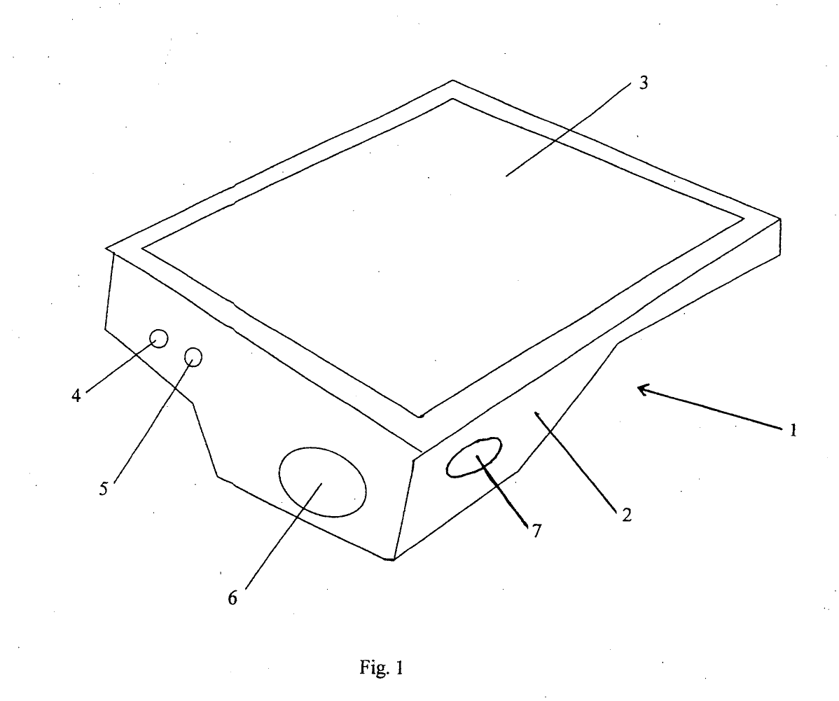

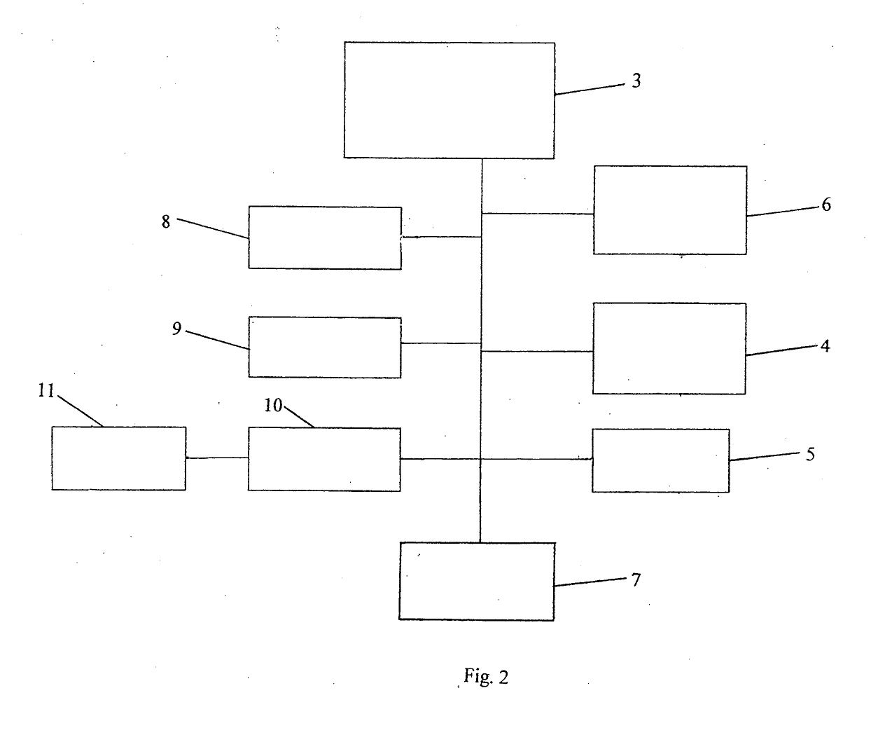

FIG. 1 shows a schematic view of an exemplary embodiment of a projection and recording device according to the invention, generally indicated with reference numeral 1. The projection and recording device 1 comprises a housing 2, having at the topside a touch screen 3, and at the front a camera 4, a microphone 5, a projector 6, and at one of the lateral sides a loudspeaker 7. The housing also comprises a memory 8, a processing unit 9 and an input/output interface 10, which are not shown but schematically indicated in FIG. 2. FIG. 2 further shows that the device 1 is coupled with a user system 11, which in this exemplary embodiment of the invention is a 3-Dimensional drawing system. The touch screen 3, camera 4, microphone 5, projector 6, loudspeaker 7, memory 8, processing unit 9 and i/o interface 10 are each connected with a bus and via this bus with each other. The memory 8 stores control programs, which are executed by the processing unit 9 and which serve for controlling the touch screen 3, camera 4, microphone 5, projector 6, loudspeaker 7 and input/output interface 10, and for editing and processing data, as will be described in more detail later. The memory 8 also has storage space available for images and sound. These images may be provided by the camera 4, the touch screen 3 and the drawing system 11. These images can be projected by the projector and can be displayed on the touch screen. The sound is obtained from the microphone and, as in the case of images that are associated with the sound, are provided with a synchronization attribute. Via the touch screen it is further possible to call various menus for controlling the functions of the projection and recording device 1, as well as for controlling the drawing system 11. With the aid of suitable modules, the control functions are moreover able to determine the position and orientation of objects recorded by the camera, and to provide images stored in the memory with position and orientation attributes. Data relating to position and orientation of the objects recorded by the camera may be derived from signals from the camera and/or from signals obtained from sensors suitable for this purpose and which may be entered into the system via, for example, the input/output interface 10. The functionality further comprises a module for adjusting the perspective on the basis of the position and orientation attributes of the stored image in association with the position and orientation of images recorded at that moment, in order to allow images to be projected in the correct position and in the correct orientation with regard to images recorded at that moment, that is to say the surroundings of the device 1 at that moment. The projected images and the surroundings, upon which they are projected, can then be simultaneously displayed on the touch screen.

The device 1 and the above-described functionality may, for example, be used to modify and change a design of an actually existing prototype or model. The device 1 is directed such as to bring the model into vision of the camera 4. An image of the model subsequently appears on the touch screen 3. With the aid of the functionality of the 3-Dimensional drawing system 11 this image can be modified using the touch screen 3 and this modification can be projected onto the model, giving an instantaneous impression of the result of the modification. All the modifications can be stored, if desired provided with commentary, to be reproduced later without having to carry out the various modifications and/or changes anew.

With a device according to the invention, it is thus possible to visually reproduce modifications and changes without physically subjecting the model or prototype to these modifications and/or changes. After having viewed numerous alternatives, it is thus possible to work quickly and interactively towards a final design, without actually having to implement all these alternatives.

Although the above invention has been described by way of a specific exemplary embodiment and with reference to a particular application of this embodiment, the invention is not limited to these, the invention is defined by the appended claims.

What is claimed is:

1. A projection and recording device, provided with a processing and control unit, a memory for recording images and other data, an input/output interface, a controllable camera, a touch screen for the input and display of data and images, a position determining system for determining the position of at least one object in relation to the projection and recording device, with images recorded by the camera being storable in the memory and displayable on the touch screen, and a projector for projecting an image stored in the memory onto the at least one object, wherein the cooperation between the position determining system and the projector enables the projector to project images onto the object.

2. A projection and recording device according to claim 1, wherein the object is identifiable with the aid of the touch screen.

3. A projection and recording device according to claim 1, wherein the device is designed to display images that are stored in the memory on the touch screen.

4. A projection and recording device according to claim 1, wherein the device can be coupled to a user system.

5. A projection and recording device according to claim 4, wherein the user system is a 2-Dimensional drawing system, a 3-Dimensional drawing system, a simulation system, an image editing system, or a combination of these.

6. A projection and recording device according to claim 4, wherein the memory comprises images provided by the user system.

7. A projection and recording device according to claim 4, wherein the user system is controllable by means of input data entered via the touch screen.

8. A projection and recording device according to claim 1, wherein the device is controllable by means of input data entered via the touch screen.

9. A projection and recording device according to claim 1, wherein images can be stored in the memory via the touch screen.

10. A projection and recording device according to claim 1, wherein images stored in the memory are provide with position and orientation attributes.

11. A projection and recording device according to claim 10, wherein the projector projects an image taking into account the respective position and orientation attributes.

12. A projection and recording device according to claim 1, wherein the device is equipped with a microphone and the sound recorded by the microphone can be stored in the memory.

13. A projection and recording device according to claim 12, wherein the image and sound stored in the memory are provided with a synchronization attribute.

14. A projection and recording device according to claim 13, wherein the device is provided with a member for the reproduction of sound.

15. A projection and recording device according to claim 1, wherein the device is provided with several projectors.
